(19) United States
(12) Patent Application Publication
(10) Pub. No.: US 2013/0174990 A1
(43) Pub. Date: Jul. 11, 2013

(54) RETAINER FOR A SHADE BOTTOM BAR AND METHOD OF ASSEMBLING

(71) Applicant: Harry E. ASBURY, Holt, FL (US)

(72) Inventor: Harry E. ASBURY, Holt, FL (US)

(21) Appl. No.: 13/347,900

(22) Filed: Jan. 11, 2012

(51) Int. Cl. E06B 9/42; B23P 11/00

(52) U.S. Cl. 160/264; 29/428

(57) ABSTRACT

A shade assembly includes a shade having one end mounted to a roll and a hem bar assembly coupled to an end of the shade opposite the roll. The hem bar assembly includes a reinforcement assembly attached to the shade and a retainer that receives the reinforcement assembly so that the reinforcement assembly is self-centering with the retainer.

### TECHNICAL FIELD

The present invention is directed to shade or blind assemblies. In particular, the present invention is directed to a shade or blind assembly with a self-centering bottom bar. Specifically, the present invention is directed to a shade or blind assembly with a bottom bar that hangs straight without tilting in either direction.

### BACKGROUND ART

Shade or blind assemblies used with windows or similar openings are well known. The assemblies provide for privacy when desired and block sunlight or allow sunlight to enter a room. Many types of shades are configured with vertical or horizontal slats that are raised and lowered, or moved sideways, by a chord wherein the angular position adjustment of the slats can also be provided. Both adjustments can be automated or manually implemented.

Roll shades are shades with one end attached to a roll which is rotatably mounted to brackets or the like maintained at a top of a window. In an open shade position, the shade is completely wrapped around the roll and in a closed shade position a majority of the shade is pulled off of the roll to cover the window. Manual roll shades utilize a gear mechanism within the roll or attachment of the roll to a bracket on either end thereof so as to hold the shade in a desired position. In an automated roll type shade, a motor or the like maintains the desired shade position with respect to the window.

Regardless of whether a manual or automated roll shade is utilized, the shade usually employs a rigid or reinforced bottom edge. The bottom edge's primary purpose is to keep the shade in a relatively parallel flat position next to the window when in a closed position. The bottom edge may also be used for grasping the shade when manually moving the shade from one position to another.

A common problem with a bottom shade edge or what is referred to herein as a hem bar is that the edge tilts or leans forward or backward with respect to the shade. Over time, this tilting causes the shade material to buckle or become deformed thereby making the shade uneven as it is collected or removed from the roll. The tilting of the bottom bar also puts uneven wear at the connection point between the shade and the bar which results in early breakage.

One known type of retainer found in use with roll-type shades is referred to as a “Keder.” A Keder is a textile reinforcement product used in many applications such as side border edging of banners, tents, awnings, industrial curtains, tarapaulins, pool covers, marine products and so on. The Keder is utilized with any application where reinforced sides are needed to handle tension and other forces. One type of Keder has a rope-wrapped outside edge secured to the fabric for additional strength. In most cases, the outside edge of the fabric using the Keder is retained under tension so it is not important to have the retainer centered. However, when used with shade configurations, the bottom edge of a shade or blind is only under tension for the weight of the bottom bar or rail and can cause the shade or the blind to buckle if not properly centered.

Therefore, there is a need for a bottom bar that hangs straight without the shade or blind material buckling or tilting the bottom bar forward or rearward. There is also a need for a bottom bar wherein the shade is provided with a reinforcement assembly that is maintained within a retainer such that it is self-centering and precludes tilting of the bottom bar. There is also a need for this bottom bar to be easily inserted and assembled and if needed removed. Indeed, there is a need for a shade or blind bottom bar with a reinforcement assembly insertable into a retainer that holds the shade or blind fabric centered in the bar so that the bottom hangs straight and will not tilt to either side. And there is a need for the reinforcement assembly to be constructed of a material that is flexible when inserted into the retainer and biases rigid portions of the reinforcement assembly toward centering wings of the retainer holding the shade and reinforcement assembly in a centered position.

### SUMMARY OF THE INVENTION

In light of the foregoing, it is a first aspect of the present invention to provide a retainer for a shade bottom bar and method of assembling.

It is another aspect of the present invention to provide a shade assembly, comprising a shade having one end mounted to a roll, a hem bar assembly coupled to an end of the shade opposite the roll, the hem bar assembly comprising a reinforcement assembly attached to the shade, and a retainer receiving the reinforcement assembly such that the reinforcement assembly is self-centering with the retainer.

Yet another aspect of the present invention is a method of assembling a hem bar assembly to a roll shade assembly comprising securing a reinforcement assembly to a pull edge of a shade, the reinforcement assembly comprising a pair of rigid pads spaced apart by a flexible section, providing a tubular body having a longitudinal slot that opens into a cavity formed by the body, inserting the reinforcement assembly into the cavity such that the reinforcement assembly self-centers within the tubular body.

### BRIEF DESCRIPTION OF THE DRAWINGS

This and other features and advantages of the present invention will become better understood with regard to the following description, appended claims, and accompanying drawings wherein:

FIG. 1 is a perspective view of a roll shade assembly with a bottom bar made in accordance with the concepts of the present invention;

FIG. 2 is a perspective view of a reinforcement assembly attached to a shade in accordance with the concepts of the present invention;

FIG. 3 is an exploded elevational view of the reinforcement assembly attached to the shade; and

FIG. 4 is an end view of a retainer receiving a folded reinforcement assembly so as to self-center a bottom bar to the shade according to the concepts of the present invention.

### BEST MODE FOR CARRYING OUT THE INVENTION

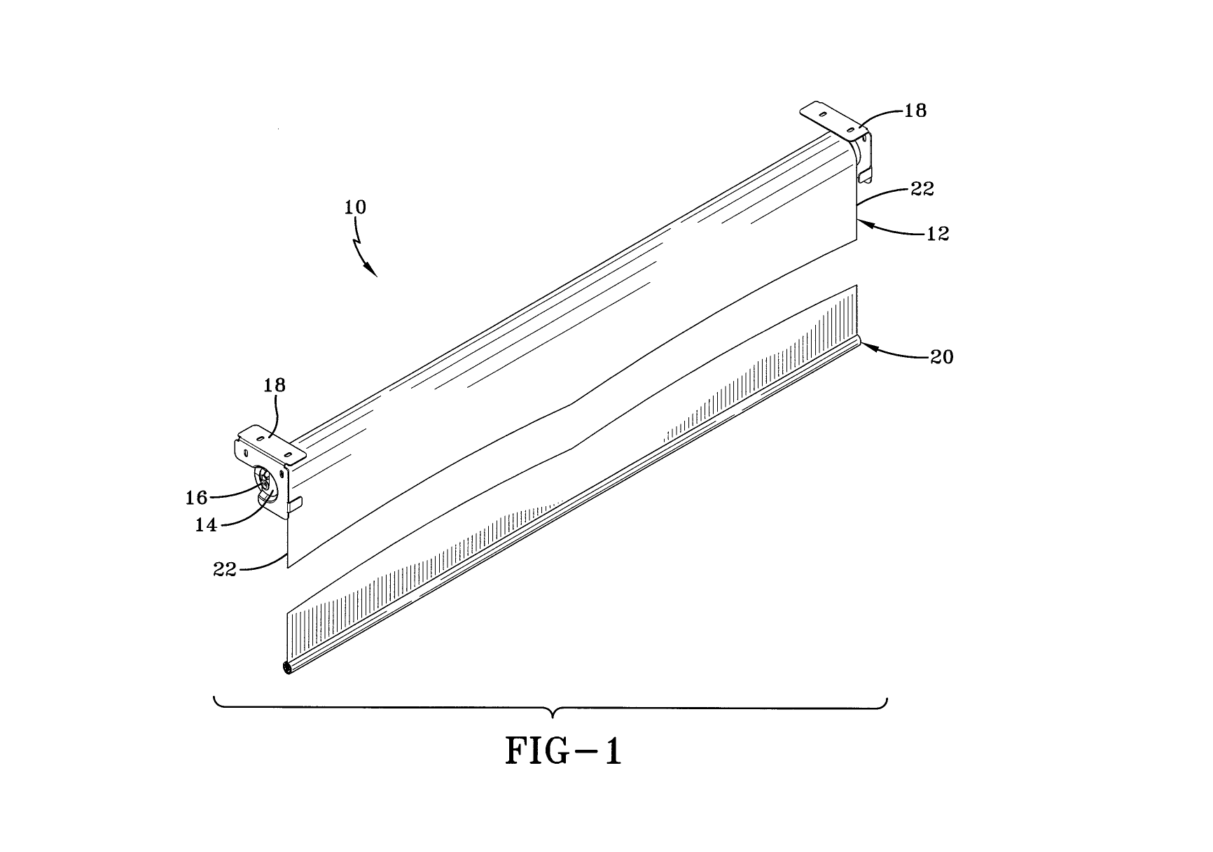

Referring now to the drawings and in particular to FIG. 1, it can be seen that a roll shade assembly is designated generally by the numeral 10. It will be appreciated that the assembly 10 is mounted into a frame that supports a window or other opening such that the assembly can be used to cover the window when desired. In particular, the roll shade assembly 10 includes a shade 12 which may sometimes be referred to as a blind, curtain or the like. One end of the shade 12 is attached to a roll 14 which is typically in the form of a cylinder with opposed ends. Extending from the ends of the roll 14 are shafts 16 which are received in respective end brackets 18. Gearing mechanisms and/or ball bearings and/or bushings allow the roll to rotate with respect to the shafts. The end brackets are mounted to a frame of the window or appropriate structure in a manner well known in the art. Secured to an edge of the shade 12 opposite the end attached to the roll 14 is a hem bar assembly 20. The hem bar assembly, which may also be referred to as a bottom bar assembly, is attached to the shade so as to allow for manually gripping one end of the shade if desired and also for the purpose of maintaining the shade in a relatively flat parallel condition when in a closed position with respect to the window or opening.

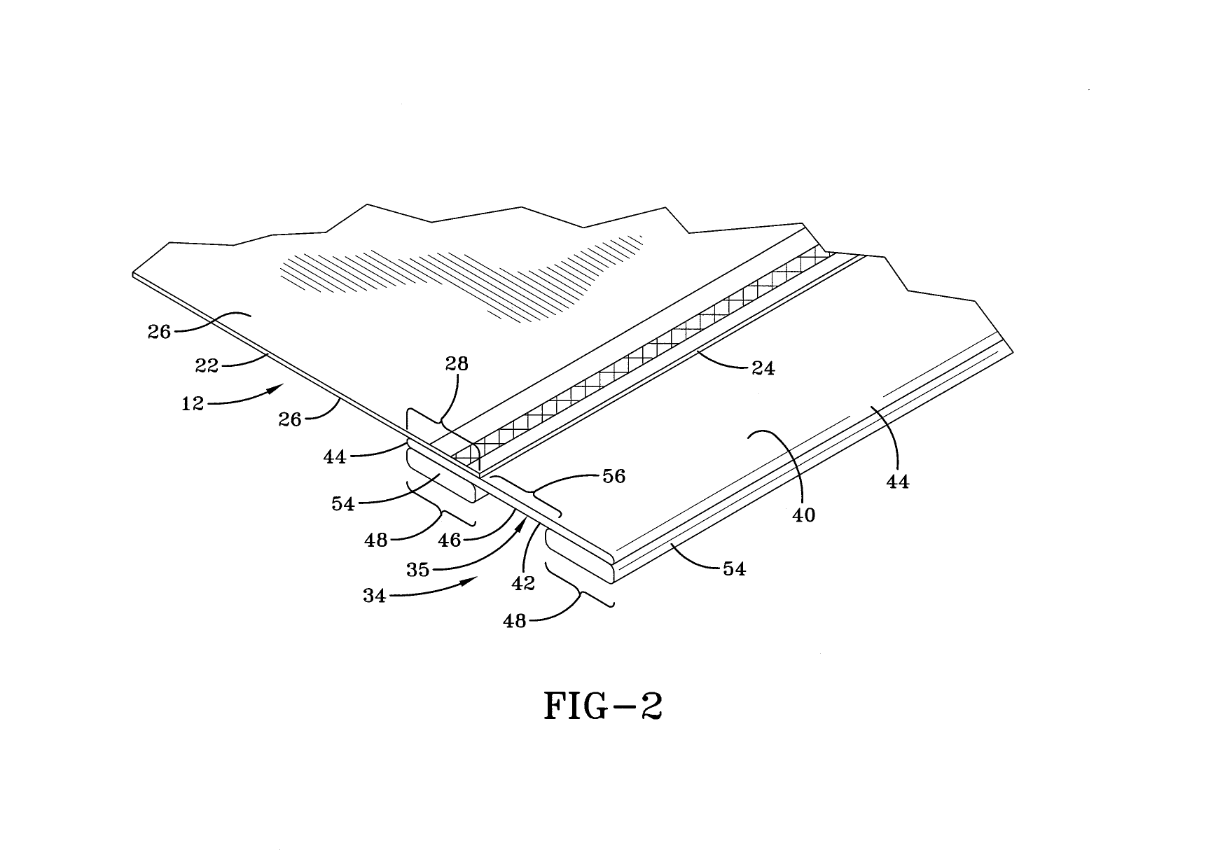

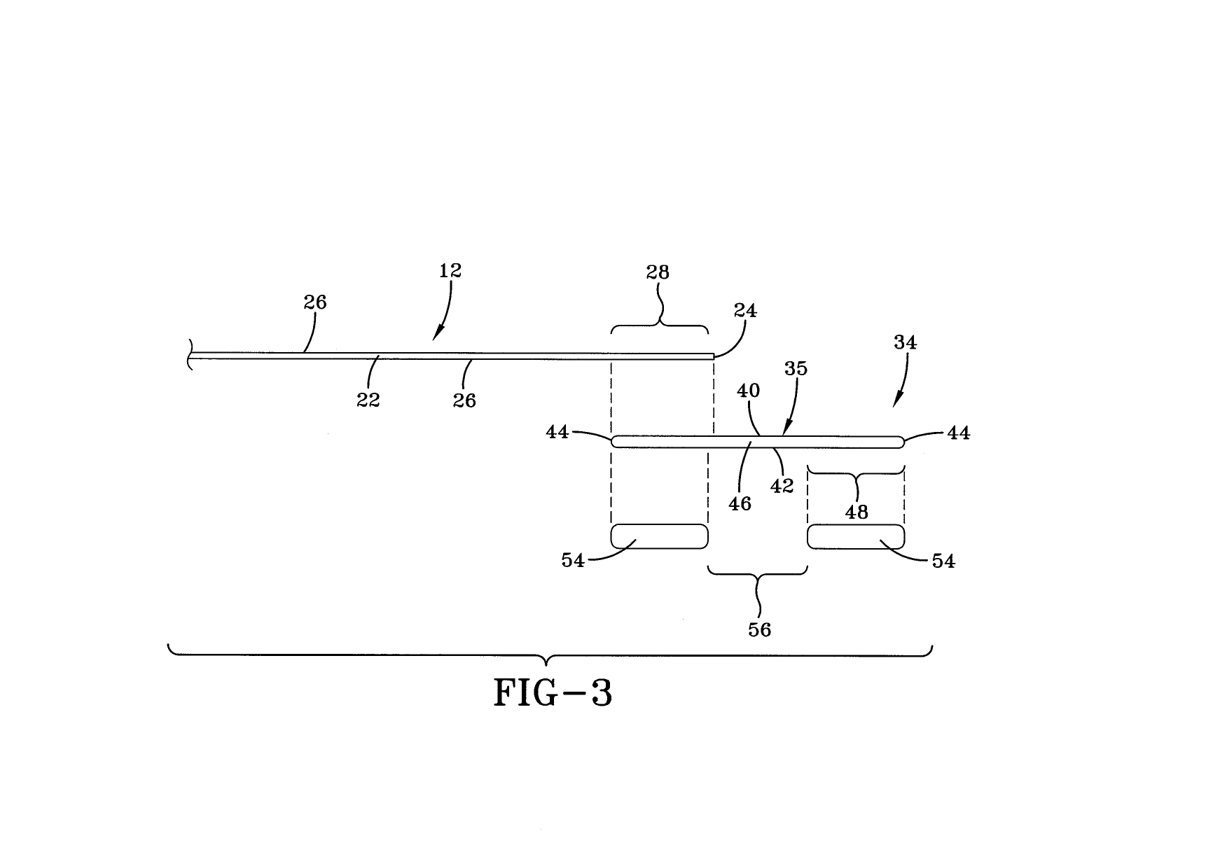

As best seen in FIGS. 2 and 3, the shade 12 includes opposed side edges 22 and a bottom edge 24 that interconnects the side edges 22 to one another. The bottom edge 24 is the end of the shade opposite the end attached to the roll 14. The shade 12 has opposed surfaces 26 wherein one surface faces the opening and the other surface faces the interior of the enclosure which has the opening. The shade 12 provides an attachment area 28 which may be along either of the surfaces 26 and extends from both side edges 22 along the bottom edge 24. The attachment area 28 can be somewhat displaced from the edges as described or may be flush with the edges. In other words, the attachment area 28 is generally located along the surface 26 in close proximity to the bottom edge 24 and extends substantially from side edge 22 to side edge 22. Although in the described embodiment the attachment area is only along one of the surfaces 26, it will be appreciated that the attachment area 28 could be on either surface or in some embodiments on both surfaces.

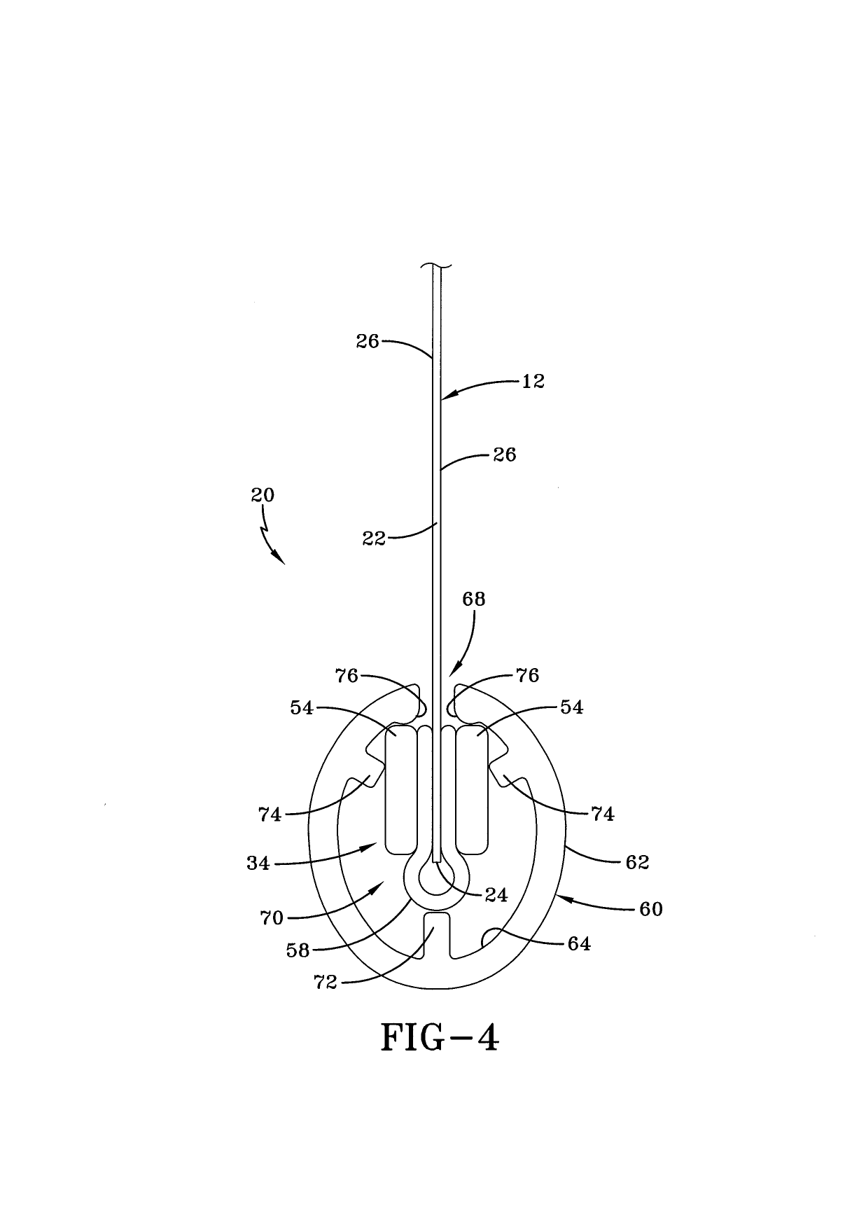

Referring now to FIGS. 2-4, the construction and assembly of the hem bar assembly 20 is shown. In FIGS. 2 and 3, it can be seen that a reinforcement assembly 34 is assembled to the shade 12 and in FIG. 4 it can be seen that the reinforcement assembly 34 and shade 12 are received within a retainer 36. The reinforcement assembly 34 comprises a flexible strip 35 which is made of a relatively soft durometer material. In one embodiment, the flexible strip is made from a polymeric material having an instantaneous durometer hardness of about 80 Shore A and about 72 Shore A at 15 seconds. The flexible strip 35 includes a shade surface 40 which is opposite a pad surface 42. The flexible strip 35 includes opposed lengthwise edges 44 which are connected to one another by widthwise edges 46. It will be appreciated that the length-wise edge 44 is substantially, but not required to be, the same length as the width of the shade 12 and in particular the bottom edge 24. In most embodiments, the reinforcement assembly 34 is the same length as the bottom edge 24; however, in other embodiments it will be appreciated that the reinforcement assembly could be of shorter length wherein several reinforcement assemblies are strategically placed along the length of the bottom edge 24. In any event, the flexible strip 35 includes spaced apart border surfaces 48 along the pad surface 42. Indeed, each border surface 48 is a portion of the pad surface 42 along each lengthwise edge 44 of the flexible strip. It will also be appreciated that the border surfaces 48 may extend and be adjacent to the widthwise edges 46. Each border surface 48 may be flush with or slightly displaced from the respective edges. Attached to the flexible strip 35 and spaced apart from one another and attached along the border surfaces 48 are rigid pads 54. The rigid pads face in the same direction as each other but are spaced apart so as to form a flexible section 56 therebetween. The rigid pads 54 are constructed of a rigid plastic material which is relatively harder than the material used for the flexible strip 35. In one embodiment, the rigid pads are made from a polymeric material having a durometer of about 80 Shore D. Although the hem bar assembly 20 can be manually constructed as described above, it will also be appreciated that a co-extrusion process could be employed. A co-extrusion dye and the relatively softer polymeric material would be configured to form the flexible strip 35 with a first portion of the die. a second portion of the co-extrusion die and the relatively harder polymeric material would be used to form the rigid pads 54. The polymeric materials could be dissimilar, but in most embodiments it is believed that the materials would be similar so as to obtain molecular bonding between the strip and the pads during the extrusion process. In any event, in the present embodiment, the retainer assembly is configured so that the flex section 56 is sized and positioned between the rigid pads 54 which are folded toward one another so that they are placed adjacent to one another but facing in the opposite directions. This results in formation of a nub 58 at the flex section wherein the size and shape of the nub is dependent upon the distance separating the rigid pads 54 from one another.

As best seen in FIG. 4, the reinforcement assembly 34 is received in the retainer 36. The retainer 36 is a generally tubular body 60 which has an outer surface 62 and an interior surface 64. The tubular body 60 provides a longitudinal slot 68 which extends along substantially the entire length of the tubular body 60. The tubular body 60 also provides a cavity 70 which is contiguous with the longitudinal slot 68.

A plurality of protrusions extend inwardly from the interior surface 64. In particular, a central protrusion 72 extends inwardly from the interior surface 64 at a position directly opposite the longitudinal slot 68. In other words, the central protrusion 72 is positioned about 180 degrees away from the position of the slot 68. A pair of pad protrusions 74 also extend inwardly from the interior surface 64 and are positioned approximately 60 degrees from each side of the central protrusion 72. The interior surface 64 may also provide a pair of ledges 76 extending from the interior surface 64 near the longitudinal slot 68.

The reinforcement assembly 34 is assembled to the shade edge 24 and then folded in such a manner so as to be received within the retainer 36. In particular, the shade surface 40 of the flexible strip is attached to the attachment area 28 provided on the bottom edge 24 of the shade 12. The reinforcement assembly 34 is then folded such that the rigid pad 54 not directly aligned with the shade edge is folded to the opposite side of the shade so as to form the nub 58. This folded configuration is then inserted into the tubular body 60 so that the rigid pads 54 are in contact with distal ends of the respective or corresponding pad protrusions 74. It will further be appreciated that exterior edges of the rigid pads may come in contact with the respective ledges 76. It will be further appreciated that the nub 58 comes in contact with a distal end of the central protrusion 72. This contact maintains the pads in a biasing manner so as to ensure that the retainer 36 does not tilt to one side or the other. In other words, the shade 12 self-centers and hangs directly straight down without undue forces tilting the shade in one direction or another.

Based on the foregoing, the advantages of the present invention should be readily apparent. In particular, the hem bar assembly 20 hangs straight without the shade or blind material buckling or tilting the hem bar forward or rearward. In view of the rigid pads having a harder durometer than the flexible strip, the rigid pads self-position the assembly 34 within the retainer. The open cavity of the retainer allows for easy insertion and removal of the reinforcement assembly from the retainer as needed. If desired, caps may be placed at the ends of the tubular body so as to ensure that the shade is not accidentally removed from the retainer during use. It will be further appreciated that the softer durometer of the flexible section provides for a biasing function causing the rigid pads to be held against the protrusions inside the retainer 36. Indeed, the combination of the biasing function of the flexible section and the locating function of the protrusions keep the retaining assembly centered in the retainer thereby preventing the assembly 20 from tilting in one direction or another and preventing a bulge or buckle from forming in the shade or blind during use.

Thus, it can be seen that the objects of the invention have been satisfied by the structure and its method for use presented above. While in accordance with the Patent Statutes, only the best mode and preferred embodiment has been presented and described in detail, it is to be understood that the invention is not limited thereto or thereby. Accordingly, for an appreciation of the true scope and breadth of the invention, reference should be made to the following claims.

What is claimed is:

1. A shade assembly, comprising:
a shade having one end mounted to a roll;
a hem bar assembly coupled to an end of said shade opposite said roll, said hem bar assembly comprising:
a reinforcement assembly attached to said shade, and
a retainer receiving said reinforcement assembly such that said reinforcement assembly is self-centering with said retainer.

2. The shade assembly according to claim 1, wherein said reinforcement assembly comprises:
a flexible strip having opposed surfaces, each surface having spaced apart lengthwise edges; and
a rigid pad coupled to each said lengthwise edge.

3. The shade assembly according to claim 2, wherein said rigid pads are spaced apart from one another so as to form a flex section therebetween.

4. The shade assembly according to claim 3, wherein said retainer assembly comprises:
a tubular body having a longitudinal slot, said body having a cavity, said cavity receiving said reinforcement assembly so that said flexible strip and said rigid pads are received in said cavity and said shade extends through said longitudinal slot.

5. The shade assembly according to claim 4, wherein said retainer assembly further comprises:
at least one protrusion inwardly extending from said tubular body and contacting at least one of said rigid pads.

6. The shade assembly according to claim 5, wherein said reinforcement assembly is folded such that said rigid pads face away from each other so as to form a nub from said flex section.

7. The shade assembly according to claim 6, wherein said retainer assembly further comprises a central protrusion inwardly extending from said tubular body toward said longitudinal slot, said nub disposed in proximity to said central protrusion.

8. The shade according to claim 7 wherein said flex section has a durometer solfter than said rigid pads.

9. A method of assembling a hem bar assembly to a roll shade assembly comprising:
securing a reinforcement assembly to a pull edge of a shade, said reinforcement assembly comprising a pair of rigid pads spaced apart by a flexible section;
providing a tubular body having a longitudinal slot that opens into a cavity formed by said body;
inserting said reinforcement assembly into said cavity such that said reinforcement assembly self-centers within said tubular body.

10. The method according to claim 9, further comprising:
providing said tubular body with at least one inwardly extending protrusion to self-center said reinforcement assembly.

11. The method according to claim 10, further comprising:
attaching said reinforcement assembly to said pull edge so that one of said rigid pads extends substantially along an entire length of said pull edge;
folding said flexible section so that said rigid pads face away from one another and form a nub therebetween, said folded flexible section centrally maintained when said reinforcement assembly is received in said tubular body.

12. The method according to claim 11, further comprising:
providing said tubular body with two inwardly extending protrusions wherein each said protrusion is in engaging contact with one of said corresponding rigid pads.

13. The method according to claim 12 further comprising:
providing said tubular body with a central protrusion inwardly extending from said tubular body toward said longitudinal slot, said central protrusion disposed in proximity to said nub.

14. The method according to claim 13, further comprising:
providing said flexible section with a softer durometer material then said rigid pads.

15. The method according to claim 9, further comprising:
forming said reinforcement assembly with a co-extrusion process, wherein said flexible strip is relatively softer than said rigid pads.

16. The method according to claim 9, further comprising:
forming said reinforcement assembly manually, wherein aid flexible strip is relatively softer than said rigid pads.
